(19) United States
(12) Patent Application Publication
(10) Pub. No.: US 2024/0034528 A1
(43) Pub. Date: Feb. 1, 2024

(54) MOTORCYCLE SADDLEBAGS HOLDER

(71) Applicant: Chuck Procopio, Norton, MA (US)

(72) Inventor: Chuck Procopio, Norton, MA (US)

(21) Appl. No.: 18/140,396

(22) Filed: Apr. 27, 2023

Related U.S. Application Data
(60) Provisional application No. 63/336,951, filed on Apr. 29, 2022.

(51) Int. Cl. B65D 61/00; B65D 63/10

(52) U.S. Cl. CPC B65D 61/00; B65D 63/109; B62J 9/20

(57) ABSTRACT

Motorcycle saddlebags can be easily scratched or damaged when not installed on a motorcycle (i.e., when left free-standing on the ground). When motorcycle saddlebags are off of the motorcycle they are generally sat on the ground loosely or hung on a wall. Storing motorcycle saddlebags loosely on the ground increases the probability that the saddlebags will be damaged or scratched. Storing motorcycle saddlebags on a wall takes up valuable storage space when the motorcycle saddlebags are not in use. Utilizing a motorcycle saddlebags retention device as disclosed herein allows for a user to safely store the motorcycle saddlebags on the ground in a free-standing orientation when the saddlebags must be removed for cleaning or maintenance. Then the motorcycle saddlebags retention device can be conveniently stored out of the way.

### CROSS-REFERENCE TO RELATED APPLICATION

This application claims the benefit of and priority to U.S. Provisional Patent Application No. 63/336,951, filed Apr. 29, 2022, the disclosure of which is incorporated by reference herein in its entirety.

### BACKGROUND

Motorcycle panniers are generally hard box containers with lids made of metal or hard plastic, and are often removable from the motorcycle. Soft cases may be made of leather or plastic, typically without permanent mountings and are often called saddlebags. Sometimes saddlebags formed of hard materials are colloquially called saddlebags. For the purpose of this description, saddlebags are considered to be hard material saddlebags or panniers. Saddlebags can be easily scratched or damaged when not installed on a motorcycle and positioned on a surface, such as pavement, due to the materials and coatings being scratchable. The cost of saddlebags can cost hundreds of dollars, and most serious motorcyclists want the saddlebags to look good (i.e., not scratched or chipped).

### SUMMARY OF THE INVENTION

One embodiment of a free-standing motorcycle saddlebag retention device may include a base member having a length and width that corresponds with a length and a width of a motorcycle saddlebag, the motorcycle saddlebag further having a height. The embodiment may further include a pair of opposed sidewalls extending from opposing sides of the base member vertically less than half of the height of the motorcycle saddlebag positioned on the base member. The embodiment further includes at least one retention member configured to maintain the motorcycle saddlebag upright on the base member between the pair of side wall members in a free-standing orientation off of a motorcycle.

A free-standing motorcycle saddlebag retention device has at least one retention member that extends vertically from the opposed sidewalls.

According to another embodiment, a free-standing motorcycle saddlebag retention device has at least one retention member that extends into at least one cavity defined by the respective sidewalls.

According to other embodiments, a free-standing motorcycle saddlebag retention device has a retaining member that is cylindrical and has a length that is at least half of the height of the saddlebag.

According to yet another embodiment, a free-standing motorcycle saddlebag retention device has at least one retention member that is elastic and is connectable or retainable to each of the opposing sidewalls.

According to one embodiment, a free-standing motorcycle saddlebag retention device has at least one retention member that is connected to respective sidewalls and is configured to extend from a closed position to an extended position and maintain the extended position to retain the motorcycle saddlebag in the free-standing position.

According to other embodiments, a free-standing motorcycle saddlebag retention device further includes an endwall that defines at least one cavity configured to accept the at least one retention member.

According to an embodiments of a method of manufacturing a free-standing motorcycle saddlebag retention device, the method includes forming a base member having a length and width, wherein the width of the base member is less than half of a height of a motorcycle saddlebag and greater than a width of the motorcycle saddlebag, wherein the length of the base member greater than or equal to the length of the motorcycle saddlebag. The method further includes extending a pair of opposed sidewalls from opposing sides of the base member vertically less than half of the height of the motorcycle saddlebag positioned on the base member. The method further includes attaching at least one retention member to at least one of the base member or the pair of opposed sidewalls, the at least one retention member configured to maintain the motorcycle saddlebag upright on the base member between the pair of side wall members in a free-standing orientation off of a motorcycle.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of a motorcycle with illustrative saddlebags;

FIG. 2 is an illustration of a front side perspective view of an embodiment of a motorcycle saddlebags holder on which saddlebags are positioned;

FIG. 3 is an illustration of a rear side perspective view of an embodiment of a motorcycle saddlebags holder on which saddlebags are positioned;

FIG. 4 is an illustration of a side perspective view of an embodiment of a motorcycle saddlebags holder on which saddlebags are positioned;

FIG. 5 is an illustration of a front perspective view of an embodiment of a motorcycle saddlebags holder on which saddlebags are positioned;

FIG. 6 is an illustration of a front perspective view of an embodiment of a motorcycle saddlebags holder on which saddlebags are positioned; and

FIG. 7 is an illustration of a front side perspective view of an embodiment of a motorcycle saddlebags holder on which saddlebags are positioned.

### DETAILED DESCRIPTION

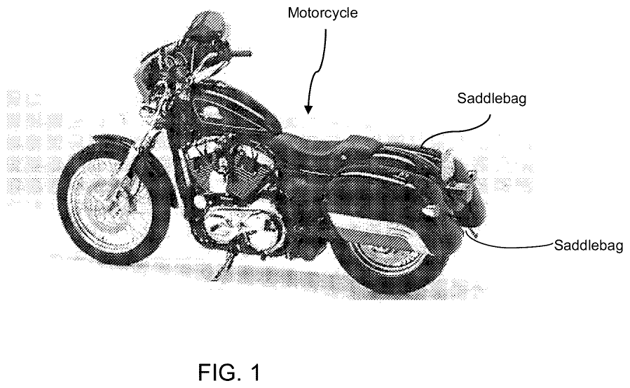

With regard to FIG. 1, an illustration of a front side perspective view of an embodiment of a motorcycle saddlebags holder on which illustrative saddlebags are positioned on the left and right sides of the rear wheel of the motorcycle. The saddlebags shown are one style, and it should be understood that a variety of sizes and shapes of saddlebags may exist and be supported by the principles described herein. The saddlebags may be detached from the motorcycle for cleaning, enabling access to the rear wheel, performing maintenance of the motorcycle, protecting contents of the saddlebags, and a variety of other reasons. Because the saddlebags are often easily scratched or damaged when placed in contact with or accidently tip onto pavement or other rough surface, owners of motorcycles have to be particularly careful when detaching the saddlebags from the motorcycle and placing the saddlebags on the ground.

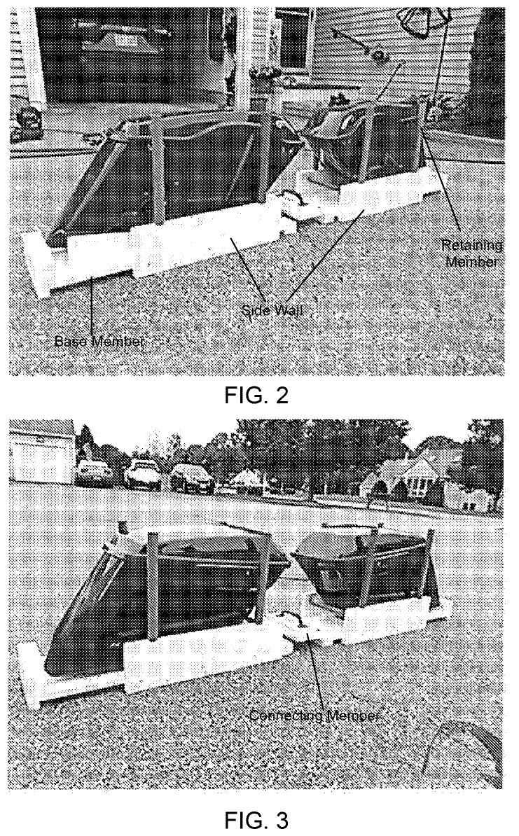

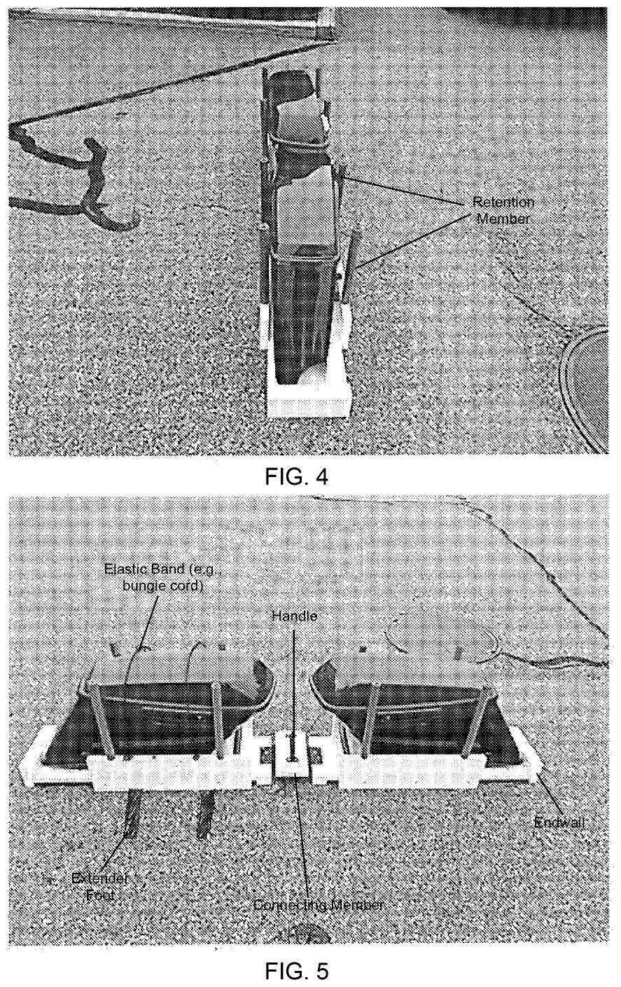

Referring to FIGS. 2-5, various perspective views of an embodiment of a motorcycle saddlebags holder as used to support saddlebags in an upright position are shown. According to one embodiment, the motorcycle saddlebags holder has one or more base members, a pair of opposed side walls, and retaining or retention members. The motorcycle saddlebags holder aids in the proper storage of motorcycle saddlebags while the motorcycle is in storage, being cleaned, or for safely storing a spare saddlebag, for example. The sidewalls are fixedly connected to the base member(s), and may provide for contacting a surface on which the holder is positioned. The base member(s), side walls, and retention members may be formed of a variety of materials. For example, the members may be formed of wood, thermoplastic, fiberglass, or any other material that may be used to support the saddlebags that may or may not be filled with items. Sharp edges or corners are to be avoided to prevent scratching the saddlebags when in contact with the holder. In an embodiment, the members may be covered with a material, such as robber, plastic, cloth, felt, or otherwise.

The base member(s) may be fixed length structure(s). Alternatively, the base member may be extendable base member(s), where the base member(s) are configured to have a telescoping mechanism to enable a user to dynamically alter the length of the base member(s). Still yet, the base member(s) may have a hinge or other mechanism that enables portions of the base member(s) to be stacked on one another to reduce footprint size when not in use. The extendable base member can be extended to a full length to fit a large saddlebag or be retracted to a shorter length for convenient storage.

The retention members as shown in FIGS. 2-5 are illustrated as being cylindrically shaped. The retention members may be in the form of a dowel, but may alternatively have any other geometric shape. The retention members may be rigid or not easily bent so as to prevent the motorcycle saddlebag(s) from causing the retention members to tilt relative to their vertical orientations. Such cylindrical members can be sized such that they may be tall enough to sufficiently prevent a motorcycle saddlebag from tipping over. As shown, the retention members, when disposed in a retention position, extend as high or higher than the saddlebags. Alternatively, the retention members can have a length of at least approximately half of the height of a motorcycle saddlebag when in the retention position such that the center of gravity of the saddlebag is the same as or below the top of the retention members. Depending on the design of some saddlebags, the length of the retention member may be less than half of the height of the saddlebags to prevent the saddlebag from tipping over. The retention members can be stored in cavities (e.g., holes or recesses) in end-walls and extend along a top surface of the base member(s) when the retention members are not in use.

As shown, the retention members may extend within and be retained by cavities defined by an upper surface of the side walls, thereby maintaining the retaining members vertical relative to a surface on which the motorcycle saddlebag holder is positioned. In this embodiment, the retention members are separable from the motorcycle saddlebags holder to enable the retention members to be stored when not in use, thereby reducing the size for storage. It should be understood that the retention members may fixed length or variable length. In a variable length configuration, the retention members may telescope or otherwise collapse into the sidewalls into a storage position from a retention position. In an alternative configuration, the retention members may be rotatably connected to the side walls such that in a storage position, the retention members may be parallel to the base member(s), and in a retention position, the retention members may be perpendicular to the base member(s).

Rather than or in addition to using the retaining member, one or more elastic straps, such as bungee cords or other elastic bands, may be used to restrict rotation of the saddlebags when positioned on the base member(s). The elastic strap(s) can be sized such that when a motorcycle saddlebag is place on the base member(s), the elastic strap(s) can be stretched over the top of the motorcycle saddlebag to secure the saddlebag to the base member of the saddlebag holder. The elastic strap(s) may be releasably connected to the side walls and/or the base member(s). Attachment features (e.g., eye screws) may be mounted to the side walls and/or base member(s) to enable hooks, for example, to connect and disconnect for securing the saddlebags to the motorcycle saddlebags holder.

According to other embodiments, the retention member can be a strap that is retained on one of the sidewalls and is configured to be positioned over the top of a motorcycle saddlebag and attach to the opposite sidewall. The strap then attaches to the opposite sidewall to secure the motorcycle saddlebag to the base member.

The cylindrical retaining members can be extendable and retractable. Such a cylindrical retention member can be capable of remaining extended to retain the motorcycle saddlebag in the freestanding position.

The pair of opposing sidewalls may be hinged to the base member. Such that when the motorcycle saddlebags retention device is stored, the opposing sidewalls may be folded flat with the base member for more compact storage of the retention device.

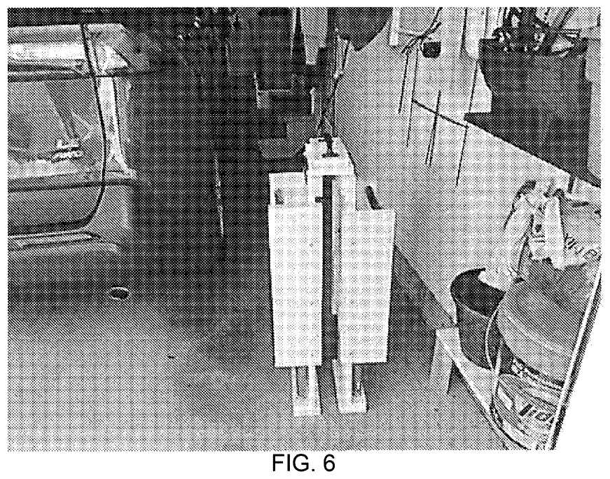

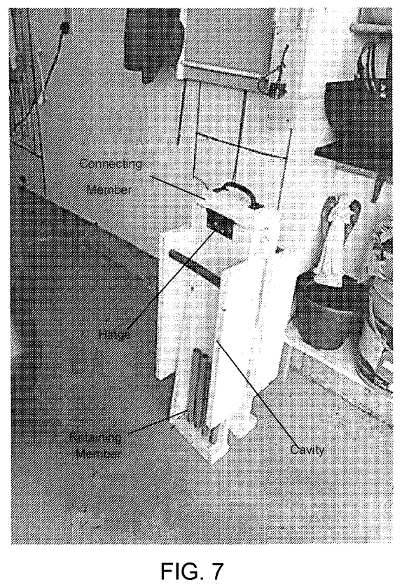

Referring now to FIGS. 6 and 7, which illustrate an embodiment of a motorcycle saddlebag retention device that is in the storage position. The illustrated embodiment shows a pair of base members, a pair of end-walls, a pair of hinges to that rotatably connect a connecting member to the pair of base members, and a handle that is fixed to the connecting member. A user may pick up the motorcycle saddlebag retention using the handle, thereby allowing bottom sides of the pair of base members to swing towards one another such that opposing ends of the base members face downwards and allow the motorcycle saddlebag retention device to stand thereon.

FIG. 7 further depicts an embodiment where the retention members may be stored in the endwalls. To store the retention members in the endwalls, the endwalls have a plurality of cavities (e.g., blind hole, recess, or thru-hole) that the retention members are configured to be set into when not in use. Although not shown, extenders may extend from the side of the base member or sidewall members so as to provide for additional lateral stability in case it is windy out or something or someone accidentally bumps into the saddlebag in the motorcycle saddlebag retention device.

According to other embodiments, the motorcycle saddlebags retention device can be quickly deployed from the storage configuration to the use configuration.

One embodiment of a method of manufacturing a free-standing motorcycle saddlebag retention device may include forming a base member having a length and width. A pair of opposed sidewalls may be extended from opposing sides of the base member. At least one retention member may be attached to at least one of the base member or the pair of opposed sidewalls. The retention member(s) may be configured to maintain the motorcycle saddlebag upright on the base member between the pair of side wall members in a free-standing orientation off of a motorcycle. Although embodiments of the motorcycle saddlebags retention device have been described in detail, those skilled in the art will also recognize that various substitutions and modifications may be made without departing from the scope and spirit of the appended claims.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes some embodiments of the disclosure, and alterations, modifications, additions and/or changes can be made thereto without departing from the scope and spirit of the disclosed embodiments, the embodiments being illustrative and not restrictive.

Furthermore, the disclosure is not to be limited to the illustrated implementations, but to the contrary, is intended to cover various modifications and equivalent arrangements included within the spirit and scope of the disclosure. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A free-standing motorcycle saddlebag retention device, the device comprising:
a base member having a length and width that corresponds with a length and a width of a motorcycle saddlebag, the motorcycle saddlebag further having a height;
a pair of opposed sidewalls extending from opposing sides of the base member vertically less than half of the height of the motorcycle saddlebag positioned on the base member; and
at least one retention member attached to the configured to maintain the motorcycle saddlebag upright on the base member between the pair of side wall members in a free-standing orientation off of a motorcycle.

2. The free-standing motorcycle saddlebag retention device of claim 1, wherein the at least one retention member extends vertically from the opposed sidewalls.

3. The free-standing motorcycle saddlebag retention device of claim 2, wherein the at least one retention member extends into at least one cavity defined by the opposed sidewalls.

4. The free-standing motorcycle saddlebag retention device of claim 1, wherein the retaining member is cylindrical and having a length of at least half of the height of the saddlebag.

5. The free-standing motorcycle saddlebag retention device of claim 1, wherein the at least one retention member is elastic and is connectable or retainable to each of the opposing sidewalls.

6. The free-standing motorcycle saddlebag retention device of claim 1, wherein the at least one retention member is connected to respective sidewalls and is configured to extend from a closed position to an extended position and maintain the extended position to retain the motorcycle saddlebag in the free-standing position.

7. The free-standing motorcycle saddlebag retention device of claim 1, further comprising an endwall defining at least one cavity configured to accept the at least one retention member.

8. A method of manufacturing a free-standing motorcycle saddlebag retention device, comprising:
forming a base member having a length and width;
extending a pair of opposed sidewalls from opposing sides of the base member; and
attaching at least one retention member to at least one of the base member or the pair of opposed sidewalls, the at least one retention member configured to maintain the motorcycle saddlebag upright on the base member between the pair of side wall members in a free-standing orientation off of a motorcycle.
